(19) United States
(12) Patent Application Publication
(10) Pub. No.: US 2026/0312125 A1
(43) Pub. Date: Oct. 8, 2026

(54) SOLID ELECTROLYTE, PREPARATION METHOD THEREOF, SOLID ELECTROLYTE MEMBRANE AND ALL-SOLID-STATE RECHARGEABLE BATTERIES

(71) Applicant: SAMSUNG SDI CO., LTD., Yongin-si, Gyeonggi-do (KR)

(72) Inventors: Sihyeon SUNG, Yongin-si, Gyeonggi-do (KR); Jinhwan PARK, Yongin-si, Gyeonggi-do (KR); Youngsoo KIM, Yongin-si, Gyeonggi-do (KR); Jeongdoo YI, Yongin-si, Gyeonggi-do (KR); Kookhan KIM, Yongin-si, Gyeonggi-do (KR); Jeongeun OH, Yongin-si, Gyeonggi-do (KR); Hyesu KIM, Yongin-si, Gyeonggi-do (KR)

(73) Assignee: SAMSUNG SDI CO., LTD., Yongin-si, Gyeonggi-do (KR)

(21) Appl. No.: 18/880,519

(22) PCT Filed: Mar. 27, 2024
(86) PCT No.: PCT/KR2024/003882

§ 371 Date: Dec. 31, 2024

(30) Foreign Application Priority Data
Jul. 11, 2023 (KR) 10-2023-0089915

(51) Int. Cl. H01M 10/0562; H01M 10/052

(52) U.S. Cl. CPC H01M 10/0562; H01M 10/052; H01M 2300/0068

(57) ABSTRACT

Disclosed are a solid electrolyte, a preparation method thereof, and a solid electrolyte membrane and an all-solid-state rechargeable battery including the same, the solid electrolyte including argyrodite-type sulfide-based solid electrolyte particles, and a bismuth compound on the surface of the particles.

### TECHNICAL FIELD

Solid electrolytes, preparation methods thereof, and solid electrolyte membranes and all-solid-state rechargeable batteries are disclosed.

### BACKGROUND ART

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

Because commercially available rechargeable lithium batteries use electrolyte solutions including flammable organic solvents, there are safety issues such as explosion or fire of the batteries in the event of collision, penetration, and the like. Accordingly, an all-solid-state rechargeable battery using a solid electrolyte instead of an electrolyte solution has been proposed. All-solid-state rechargeable batteries are batteries in which all materials are made of solid, and thus they are safe as there is no risk of electrolyte solution leaking and exploding, and have the advantage of being easy to manufacture thin batteries, and can reduce the thickness of the negative electrode, improving high-rate charging and discharging performance, and realizing high-voltage driving and high energy density.

As a solid electrolyte, a sulfide-based solid electrolyte with high ionic conductivity is mainly used. Among them, an argyrodite-type sulfide-based solid electrolyte can exhibit high ionic conductivity close to a range of 10⁻⁴ to 10⁻² S/cm, which is the ionic conductivity of a typical liquid electrolyte, at room temperature, and has the advantage of forming a close bond between solid electrolytes and a close bond between the solid electrolyte and the positive electrode active material due to soft mechanical properties. Accordingly, an all-solid-state rechargeable battery using an argyrodite-type sulfide-based solid electrolyte can exhibit improved rate capability, coulombic efficiency, and cycle-life characteristics.

However, argyrodite-type sulfide-based solid electrolytes are very vulnerable to moisture and air, and when exposed to air during the preparing process, distribution process, or battery operation, they react with H₂O, CO₂, O₂, etc. to generate by-products such as hydrogen sulfide, and there is a problem that their performance deteriorates, such as surface damage or rapid decrease in ionic conductivity.

### DISCLOSURE

Provided are argyrodite-type sulfide-based solid electrolytes that has improved moisture stability, realizes stable ionic conductivity, and improves the performance, such as cycle-life characteristics, of all-solid-state rechargeable batteries.

In an embodiment, a solid electrolyte includes argyrodite-type sulfide-based solid electrolyte particles and a bismuth compound on the surface of the particles.

In another embodiment, a method for preparing a solid electrolyte includes mixing argyrodite-type sulfide-based solid electrolyte particles and a bismuth raw material and heat-treating at 200° C. to 350° C. to obtain the solid electrolyte.

In another embodiment, a solid electrolyte membrane including the solid electrolyte is provided.

In another embodiment, an all-solid-state rechargeable battery includes a positive electrode, a negative electrode, and a solid electrolyte layer between the positive electrode and the negative electrode, wherein at least one of the positive electrode, the negative electrode, and the solid electrolyte layer includes the solid electrolyte.

The solid electrolyte according to an embodiment of the present invention includes an argyrodite-type sulfide, and has excellent atmospheric stability and moisture stability, so that the continuous decrease in ionic conductivity over atmospheric exposure time is effectively suppressed, and a relatively stable resistance value may be provided so that lithium ions can move smoothly. The solid electrolyte membrane and all-solid-state rechargeable batteries using the same can implement excellent electrochemical characteristics such as long cycle-life characteristics.

### DESCRIPTION OF THE DRAWINGS

FIGS. 1 and 2 are cross-sectional views schematically showing all-solid-state rechargeable batteries according to an embodiment.

FIG. 3 is a graph showing changes in ionic conductivity according to exposure time after leaving the solid electrolyte membranes of Example 2, Comparative Example 1, and Comparative Example 2 in a dry room.

### MODE FOR INVENTION

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, may be measured by a particle size analyzer, or may be measured by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. As used herein, when a definition is not otherwise provided, the average particle diameter means a diameter (D50) of particles having a cumulative volume of 50 volume % in the particle size distribution that is obtained by measuring the size (diameter or length of the major axis) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

### Solid Electrolyte

In an embodiment, a solid electrolyte includes argyrodite-type sulfide-based solid electrolyte particles and a bismuth compound on the surface of the particles.

The bismuth compound refers to a compound including the element bismuth. The solid electrolyte may be referred to as an argyrodite-type sulfide-based solid electrolyte surface-modified with a bismuth compound. These solid electrolytes can effectively suppress the deterioration of solid electrolytes due to exposure to the atmosphere, etc., by improving moisture stability while maintaining the high ionic conductivity of argyrodite-type sulfide systems. The solid electrolyte according to an embodiment has a concept distinct from a sulfide-based solid electrolyte prepared from a bismuth raw material, and may be expressed as a form in which a bismuth compound is coated on the surface of argyrodite-type sulfide-based particles that do not include bismuth.

The bismuth compound may be coated on at least a portion of the surface of the argyrodite-type sulfide-based solid electrolyte particles. For example, the bismuth compound may be coated on the particle surface in the form of a continuous film, or may be coated on the particle surface in the form of an island. For example, the solid electrolyte may have a core-shell structure including core particles including an argyrodite-type sulfide-based solid electrolyte and a shell surrounding the core particles and including a bismuth compound.

Here, the ‘the particles’ refer to argyrodite-type sulfide-based solid electrolyte particles.

The bismuth compound may include sulfur in addition to the bismuth element, in which case it has high affinity for the argyrodite-type sulfide-based solid electrolyte particles and may be well coated on their surfaces.

Additionally, the bismuth compound may further include lithium, wherein the lithium may be derived from, but is not particularly limited to, argyrodite-type sulfide-based solid electrolyte particles.

The bismuth compound may include, for example, Bi₂S₃, Bi₂O₅, Bi₂Se₃, BiF₃, BiF₅, BiCl₃, LiBi, Li₃Bi, LiBiS₂, NaBiS₂, LiBiO₂, LiBiO₃, LisBiO₄, Li₃BiO₅, Li₇BiO₅, Li₃BiO₃, Na₃BiO₃, LiBiSe₂, NaBiSe₂, KBiSe₂, BiOCl, BiONO₃, LiBi(PO₃)₄, or a combination thereof.

As an example, the bismuth compound may include LiBiS₂. The presence of LiBiS₂ phases may be identified through XRD analysis, etc. The LiBiS₂ is structurally stable and located on the surface of the argyrodite-type sulfide-based solid electrolyte, which can effectively suppress moisture contact, minimize the decrease in ionic conductivity due to the coating, and effectively improve an ionic conductivity retention rate of the solid electrolyte when exposed to a dry room.

The bismuth compound may be included in an amount of 0.05 mol % to 10 mol %, for example 0.05 mol % to 8 mol %, 0.1 mol % to 7 mol %, 0.1 mol % to 5 mol %, 0.1 mol % to 4 mol %, 0.1 mol % to 3 mol %, 0.1 mol % to 2 mol %, 0.1 mol % to 1 mol %, or 0.2 mol % to 0.8 mol % based on 100 mol % of the solid electrolyte. Additionally, the bismuth compound may be included in an amount of 0.1 wt % to 15 wt %, for example, 0.1 wt % to 13 wt %, 0.1 wt % to 10 wt %, 0.1 wt % to 8 wt %, 0.1 wt % to 5 wt %, 0.1 wt % to 3 wt %, or 0.3 wt % to 1.5 wt % based on 100 wt % of the solid electrolyte. The content of bismuth compound may be determined by quantitative analysis, for example, using XRD. When the bismuth compound is included in the above content range, the moisture stability of argyrodite-type sulfide-based solid electrolyte particles may be effectively improved while suppressing an increase in resistance due to the coating. For example, the bismuth compound may be included in an amount of 0.1 mol % to 1 mol %, or 0.2 mol % to 0.8 mol %, based on 100 mol % of the solid electrolyte. In this case, the moisture stability of the argyrodite-type sulfide-based solid electrolyte particles may be effectively improved while reducing the decrease in initial ionic conductivity due to the coating, thereby improving the ionic conductivity of the solid electrolyte.

The argyrodite-type sulfide-based solid electrolyte particles include argyrodite-type sulfides and exhibit high ionic conductivity close to the ionic conductivity of a general liquid electrolyte at room temperature, which is in the range of 10⁻⁴ to 10⁻² S/cm, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including the same may have improved battery performance such as rate capability, coulombic efficiency, and cycle-life characteristics.

For example, the argyrodite-type sulfide-based solid electrolyte particles may include a compound represented by Chemical Formula 1.

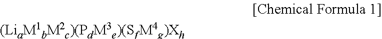

In Chemical Formula 1, 4≤a≤8, M¹ is Mg, Cu, Ag, or a combination thereof, 0≤b<0.5, M² is Na, K, or a combination thereof, 0≤c<0.5, M³ is Sn, Zn, Si, Sb, Ge, or a combination thereof, 0<d<4, 0≤e<1, M⁴ is O, SOₙ, or a combination thereof, 1.5≤n≤5, 3≤f≤12, 0≤g<2, X is F, Cl, Br, I, or a combination thereof, and 0≤h≤2.

For example, the halide element (X) may be necessarily included in Chemical Formula 1, and in this case, it may be expressed as 0<h≤2. For example, M¹ element may be necessarily included in Chemical Formula 1, and in this case, it may be expressed as 0≤b<0.5. In Chemical Formula 1, M³ may be understood as an element substituted for P and may be 0≤e<1. In Chemical Formula 1, M⁴ is substituted for S, for example may be 0<g<2, and f, a ratio of S, may be for example 3≤f≤7. If M⁴ is SOₙ, SOₙ may be for example S₄O₆, S₃O₆, S₂O₃, S₂O₄, S₂O₅, S₂O₆, S₂O₇, S₂O₈, SO₄, SO₅, and the like.

For example, in Chemical Formula 1, a+b+c+h=7, d+e=1, and f+g+h=6.

As an example, the argyrodite-type sulfide-based solid electrolyte particles may include Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}CU_{0.06})PS_{4.75}Cl_{1.25}, (Li_{5.72}Cu_{0.03})PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60}(SO₄)_{0.15})Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.025})Cl_{1.25}, Li_{5.75}P(S_{4.725}(SO₄)_{0.025})Cl_{1.25}, or a combination thereof, but are not limited thereto.

The argyrodite-type sulfide-based solid electrolyte particles may be prepared, for example by mixing lithium sulfide and phosphorus sulfide, and optionally lithium halide. Heat treatment may be performed after mixing them. The heat treatment may include, for example, two or more heat treatment steps. Here, the preparing of the argyrodite-type sulfide-based solid electrolyte particles may include, for example, a first heat treatment in which raw materials are mixed and fired at 120° C. to 350° C., and a second heat treatment in which the resultant of the first heat treatment is mixed again and fired at 350° C. to 800° C.

An average particle diameter (D50) of the argyrodite-type sulfide-based solid electrolyte particles may be less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. The solid electrolyte particles may be small particles having a size of 0.1 μm to 1.5 μm, large particles having a size of 2.0 μm to 5.0 μm, or a mixture thereof. The average particle diameter of the solid electrolyte particles may be measured using an electron microscope image, and for example, a particle size distribution may be obtained by measuring the size (diameter or length of the major axis) of about 20 particles in a scanning electron microscope image, and D50 may be calculated therefrom.

### Method of Preparing Solid Electrolyte

In an embodiment, a method for preparing a solid electrolyte includes mixing argyrodite-type sulfide-based solid electrolyte particles and a bismuth raw material and heat-treating at 200° C. to 350° C. Through the method, the solid electrolyte in which the bismuth compound is well coated on the surface of the argyrodite-type sulfide-based solid electrolyte particles may be obtained.

The bismuth raw material is not particularly limited, as long as it is a raw material containing bismuth, but may include, for example, Bi₂S₃, Bi₂O₅, Bi₂Se₃, BiF₃, BiF₅, or a combination thereof.

The bismuth raw material may be included in an amount of 0.05 mol % to 10 mol %, 0.05 mol % to 8 mol %, 0.1 mol % to 7 mol %, 0.1 mol % to 5 mol %, 0.1 mol % to 4 mol %, 0.1 mol % to 3 mol %, 0.1 mol % to 2 mol %, 0.1 mol % to 1 mol %, or 0.2 mol % to 0.8 mol % based on 100 mol % of a total amount of the argyrodite-type sulfide-based solid electrolyte particles and the bismuth raw material. If the bismuth raw material is mixed within the content ranges, an increase in resistance due to the coating may not only be suppressed, but also moisture stability of the argyrodite-type sulfide-based solid electrolyte particles may be sufficiently improved. For example, the bismuth raw material may be mixed in an amount of 0.1 mol % to 1 mol % or 0.2 mol % to 0.8 mol %, wherein the moisture stability of the argyrodite-type sulfide-based solid electrolyte particles may be effectively improved, but also a decreased in the initial ionic conductivity according to the coating may be reduced, resultantly improving ionic conductivity performance of the solid electrolyte.

The heat treatment may be, for example, performed at 210° C. to 340° C., 220° C. to 330° C., 230° C. to 320° C., 240° C. to 310° C., or 250° C. to 300° C. If the heat treatment is performed within the temperature ranges, the solid electrolyte in which the bismuth compound is well coated on the surface of the argyrodite-type sulfide-based solid electrolyte particles may be obtained.

The heat treatment may be performed for 1 hour to 12 hours, for example, for 2 hours to 10 hours. In addition, the heat treatment may be performed under an inert gas atmosphere such as argon and the like at a heating rate of 0.5° C./min to 3° C./min.

The mixing of the argyrodite-type sulfide-based solid electrolyte particles and the bismuth raw material may be, for example, performed by milling.

The method for preparing the solid electrolyte according to an embodiment may further include grinding after heat treatment.

The method for preparing the solid electrolyte may be a type of solid coating method.

### Solid Electrolyte Membrane

In an embodiment, a solid electrolyte membrane including the aforementioned solid electrolyte is provided. A solid electrolyte membrane according to an embodiment of the present invention may realize high ionic conductivity by including the aforementioned solid electrolyte, has high stability against moisture, and may realize high ionic conductivity maintenance even when exposed for a long time, and may have low side reactions of the solid electrolyte due to moisture, so that battery safety and cycle-life characteristics may be improved.

The solid electrolyte membrane may be manufactured by a conventional solvent-casting method, and in this case, it is possible to manufacture a solid electrolyte membrane with a low ionic conductivity reduction rate.

The solid electrolyte membrane may further include, in addition to the aforementioned solid electrolyte, another oxide-based solid electrolyte or a halide-based solid electrolyte, and optionally further include a binder.

### Oxide-Based Solid Electrolyte

The oxide-based solid electrolyte may include for example Li₁₊ₓTi₂₋ₓAl(PO₄)₃ (LTAP) (0≤x≤4), Li_{1+x+y}AlₓTi₂₋ₓSi_{y}Ps_{y}O₁₂ (0<x<2, 0≤y<3), BaTiO₃, Pb(Zr,Ti)O₃ (PZT), Pb₁₋ₓLaₓZr_{1-y}Tl_{y}O₃ (PLZT) (0≤x<1, 0≤y<1), PB(Mg₃Nb_{2/3})O₃—PbTiO₃ (PMN-PT), HfO₂, SITiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Te, Nb, or Zr; and x is an integer of 1 to 10), or a mixture thereof.

### Halide-Based Solid Electrolyte

The halide-based solid electrolyte contains a halogen element as a main component, meaning that a ratio of the halide element to all elements constituting the solid electrolyte may be greater than or equal to 50 mol %, greater than or equal to 70 mol %, greater than or equal to 90 mol %, or 100 mol %. For example, the halide-based solid electrolyte may not include a sulfur element.

The halide-based solid electrolyte may include a lithium element, a metal element other than lithium, and a halogen element. The metal element other than lithium may include Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof and for example it may be Cl, Br, or a combination thereof. For example, the halide-based solid electrolyte may be represented by LiₐM₁X₆ (M is Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X is F, Cl, Br, I, or a combination thereof, and 2≤a≤3). For example, the halide-based solid electrolyte may include Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof, but is not limited thereto.

The binder may include, for example, a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, polydimethylsiloxane, polyethyleneoxide, polyvinylpyrrolidone, polyvinylpyridine, chlorosulfonatedpolyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene propylene copolymer, an ethylene propylene diene copolymer, polyamideimide, polyimide, poly(meth)acrylate, polyacrylonitrile, polystyrene, polyurethane, or a combination thereof.

A content of the binder based on 100 wt % of the solid electrolyte membrane may be about 0.1 wt % to 5 wt %, or 0.5 wt % to 3 wt %.

The solid electrolyte membrane may optionally further include an alkali metal salt, and/or an ionic liquid, and/or a conductive polymer.

For example, the alkali metal salt may be lithium salt. The content of lithium salt in the solid electrolyte layer may be greater than or equal to 1 M or for example 1 M to 4 M. In this case, the lithium salt may improve ionic conductivity by improving lithium ion mobility in the solid electrolyte layer.

The lithium salt may be applied without type limitations, and may include, for example, LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato) borate (LiBOB), lithium difluorobis (oxalato) borate (LiDFOB), lithium difluorobis(oxalato)phosphate (LiDFBP), lithium bis(trifluoromethanesulfonyl)imide (LiTFSI), lithium bis(fluorosulfonyl)imide (LiFSI), lithium bis(pentafluoroethanesulfonyl)imide (LiBETI), lithium trifluoromethane sulfonate, lithium tetrafluoroethane sulfonate, or a combination thereof.

For example, the lithium salt may be an imide-based lithium salt such as LiTFSI, LiFSI, LiBETI, or a combination thereof. The imide-based lithium salt may maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including at least one cation selected from a) ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

### All-Solid-State Rechargeable Battery

In an embodiment, an all-solid-state rechargeable battery including the aforementioned solid electrolyte is provided. The all-solid-state rechargeable battery includes a positive electrode, a negative electrode, and a solid electrolyte membrane between the positive electrode and the negative electrode. The aforementioned solid electrolyte may be included in at least one of the positive electrode, the negative electrode, and the solid electrolyte membrane. In one example, an all-solid-state rechargeable battery includes a positive electrode, a negative electrode, and a solid electrolyte membrane including the aforementioned solid electrolyte.

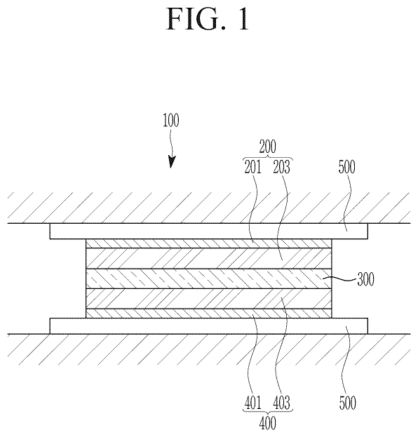

FIG. 1 is a cross-sectional view of an all-solid-state rechargeable battery according to an embodiment. Referring to FIG. 1, the all-solid-state rechargeable battery 100′ may have a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is housed in a battery case. The all-solid-state rechargeable battery 100′ may further include at least one elastic layer 500 on the outside of at least either one of the positive electrode 200 and the negative electrode 400. Although FIG. 1 shows one electrode assembly including the negative electrode 400, the solid electrolyte layer 300, and the positive electrode 200, an all-solid-state rechargeable battery can also be manufactured by stacking two or more electrode assemblies.

### Negative Electrode

A negative electrode for an all-solid-state rechargeable battery includes a current collector and a negative electrode active material layer on the current collector. The negative electrode active material layer may include a negative electrode active material, may further include a binder and/or a conductive material, may optionally include the aforementioned solid electrolyte.

The negative electrode active material includes a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

For example, the negative electrode active material may include silicon-carbon composite particles. An average particle diameter (D50) of the silicon-carbon composite particles may be for example 0.5 μm to 20 μm. The average particle diameter (D50) is measured with a particle size analyzer and means a diameter of particles with a cumulative volume of 50 volume % in the particle size distribution. Silicon may be included in an amount of 10 wt % to 60 wt % and carbon may be included in an amount of 40 wt % to 90 wt % based on 100 wt % of the silicon-carbon composite particles. For example, the silicon-carbon composite particles may include a core including silicon particles, and a carbon coating layer on the surface of the core. An average particle diameter (D50) of the silicon particles may be 10 nm to 1 μm or 10 nm to 200 nm in the core. The silicon particles may exist as silicon alone, in the form of a silicon alloy, or in an oxidized form. The oxidized form of silicon may be represented by SiOₓ (0<x<2). In addition, a thickness of the carbon coating layer may be about 5 nm to 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer. The crystalline carbon may be artificial graphite, natural graphite, or a combination thereof, and the amorphous carbon may be may be formed from coal-based pitch, mesophase pitch, petroleum-based pitch, coal-based oil, heavy petroleum oil, or a polymer resin (phenolic resin, furan resin, polyimide, etc.). Herein, a content of the crystalline carbon may be 10 wt % to 70 wt % and a content of the amorphous carbon may be 20 wt % to 40 wt % based on 100 wt % of the silicon-carbon composite particles.

In the silicon-carbon composite particle, the core may include a void in the center. A radius of the void may be 30 length % to 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si-based negative electrode active material or Sn-based negative electrode active material may be used by mixing with a carbon-based negative electrode active material. When using a mixture of Si-based negative electrode active material or Sn-based negative electrode active material and carbon-based negative electrode active material, a mixing ratio thereof may be 1:99 to 90:10 by weight.

A content of the negative electrode active material in the negative electrode active material layer may be 95 wt % to 99 wt % based on a total weight of the negative electrode active material layer.

In an embodiment, the negative electrode active material layer further includes the binder and optionally may further include the conductive material. A content of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may be polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity as a type of thickener may be further included. As this cellulose-based compound, one or more types of carboxymethyl cellulose, hydroxypropylmethyl cellulose, methyl cellulose, or an alkali metal salt thereof may be used. The alkali metal may be Na, K, or Li. The amount of the thickener used may be 0.1 parts by weight to 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state rechargeable battery may be a precipitation-type negative electrode. The precipitation-type negative electrode does not include a negative electrode active material during battery assembly, but may refer to a negative electrode in which lithium metal, etc. is precipitated or electrodeposited on the negative electrode during battery charging, thereby serving as a negative electrode active material.

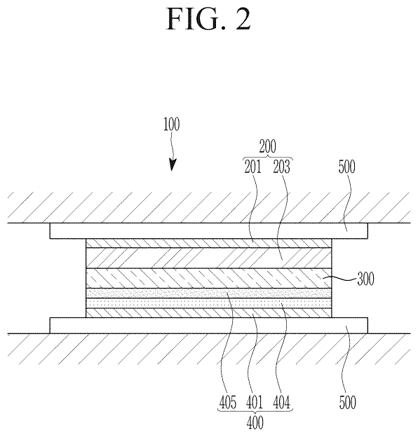

FIG. 2 is a schematic cross-sectional view of an all-solid-state rechargeable battery including a precipitation-type negative electrode. Referring to FIG. 2, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector, and a negative electrode coating layer 405 on the metal layer. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

In this case, the aforementioned region or first solid electrolyte layer may be referred to as a surface in contact with the negative electrode coating layer 405.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to about 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode coating layer 405 includes the metal and the carbon material, the metal and the carbon material may be, for example, mixed in a weight ratio of 1:10 to 2:1. Herein, the precipitation of the lithium metal may be effectively promoted and improve characteristics of the all-solid-state battery. The negative electrode coating layer 405 may include, for example, a carbon material on which a catalyst metal is supported or a mixture of metal particles and carbon material particles.

The negative electrode coating layer 405 may include, for example the lithiophilic metal and amorphous carbon, and in this case, the deposition of lithium metal may be effectively promoted. As a specific example, the negative electrode coating layer 405 may include a composite in which a lithiophilic metal is supported on amorphous carbon.

The negative electrode coating layer 405 may further include a binder, and the binder may be, for example, a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm m to 5 μm.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example in a vacuum deposition method, a sputtering method, a plating method, and the like. The thin film may have, for example, a thickness of 1 nm to 500 nm.

The lithium metal layer 404 may include lithium metal or lithium alloy. For example, the lithium alloy may be Li—Al alloy, Li—Sn alloy, Li—In alloy, Li—Ag alloy, Li—Au alloy, Li—Zn alloy, Li—Ge alloy, or Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

### Positive Electrode

In an embodiment, the positive electrode includes a current collector and a positive electrode active material layer on the current collector, wherein the positive electrode active material layer includes a positive electrode active material and a solid electrolyte, and optionally a binder and/or a conductive material. At this time, the positive electrode active material layer may include the solid electrolyte described above.

### Positive Electrode Active Material

The positive electrode active material may be applied without limitation as long as it is generally used in all-solid-state rechargeable batteries. For example, the positive electrode active material may be a compound being capable of intercalating and deintercalating lithium, and may include a compound represented by one of the following chemical formulas.

$${Li}_{a} {A}_{1 - b} {X}_{b} {D}_{2} ( 0.9 \leq a \leq 1.8 , 0 \leq b \leq 0.5 ) ;$$

$${Li}_{a} {A}_{1 - b} {X}_{b} {O}_{2 - c} {D}_{c} ( 0.9 \leq a \leq 1.8 , 0 \leq b \leq 0.5 , 0 \leq c \leq 0.05 ) ;$$

$${Li}_{a} {E}_{1 - b} {X}_{b} {O}_{2 - c} {D}_{c} ( 0.9 \leq a \leq 1.8 , 0 \leq b \leq 0.5 , 0 \leq c \leq 0.05 ) ;$$

$${Li}_{a} {E}_{2 - b} {X}_{b} {O}_{4 - c} {D}_{c} ( 0.9 \leq a \leq 1.8 , 0 \leq b \leq 0.5 , 0 \leq c \leq 0.05 ) ;$$

$${Li}_{a} {Ni}_{1 - b - c} {Co}_{b} {X}_{c} {D}_{α} ( 0.9 \leq a \leq 1.8 , 0 \leq b \leq 0.5 , 0 \leq c \leq 0.05 , 0 < α \leq 2 ) ;$$

$${Li}_{a} {Ni}_{1 - b - c} {Co}_{b} {X}_{c} {O}_{2 - α} {T}_{α} ( 0.9 \leq a \leq 1.8 , 0 \leq b \leq 0.5 , 0 \leq c \leq 0.05 , 0 < α \leq 2 ) ;$$

$${Li}_{a} {Ni}_{1 - b - c} {Co}_{b} {X}_{c} {O}_{2 - α} {T}_{2} ( 0.9 \leq a \leq 1.8 , 0 \leq b \leq 0.5 , 0 \leq c \leq 0.05 , 0 < α \leq 2 ) ;$$

$${Li}_{a} {Ni}_{1 - b - c} {Mn}_{b} {X}_{c} {D}_{α} ( 0.9 \leq a \leq 1.8 , 0 \leq b \leq 0.5 , 0 \leq c \leq 0.05 , 0 < α \leq 2 ) ;$$

$${Li}_{a} {Ni}_{1 - b - c} {Mn}_{b} {X}_{c} {O}_{2 - α} {T}_{α} ( 0.9 \leq a \leq 1.8 , 0 \leq b \leq 0.5 , 0 \leq c \leq 0.05 , 0 < α \leq 2 ) ;$$

$${Li}_{a} {Ni}_{1 - b - c} {Mn}_{b} {X}_{c} {O}_{2 - α} {T}_{2} ( 0.9 \leq a \leq 1.8 , 0 \leq b \leq 0.5 , 0 \leq c \leq 0.05 , 0 < α \leq 2 ) ;$$

$${Li}_{a} {Ni}_{b} {E}_{c} {G}_{d} {O}_{2} ( 0.9 \leq a \leq 1.8 , 0 \leq b \leq 0.9 , 0 \leq c \leq 0.5 , 0.001 \leq d \leq 0.1 ) ;$$

$${Li}_{a} {Ni}_{b} {Co}_{c} {Mn}_{d} {G}_{e} {O}_{2} ( 0.9 \leq a \leq 1.8 , 0 \leq b \leq 0.9 , 0 \leq c \leq 0.5 , 0 \leq d \leq 0.5 , 0.001 \leq e \leq 0.1 ) ;$$

$${Li}_{a} {Ni G}_{b} {O}_{2} ( 0.9 \leq a \leq 1.8 , 0.001 \leq b \leq 0.1 ) ;$$

$${Li}_{a} {Co G}_{b} {O}_{2} ( 0.9 \leq a \leq 1.8 , 0.001 \leq b \leq 0.1 ) ;$$

$${Li}_{a} {Mn}_{1 - b} {G}_{b} {O}_{2} ( 0.9 \leq a \leq 1.8 , 0.001 \leq b \leq 0.1 ) ;$$

$${Li}_{a} {Mn}_{2} {G}_{b} {O}_{4} ( 0.9 \leq a \leq 1.8 , 0.001 \leq b \leq 0.1 ) ;$$

$${Li}_{a} {Mn}_{1 - g} {G}_{g} {PO}_{4} ( 0.9 \leq a \leq 1.8 , 0 \leq g \leq 0.5 ) ;$$

$${Q O}_{2} ; {Q S}_{2} ; {Li Q S}_{2} ;$$

$${V}_{2} {O}_{5} ; {LiV}_{2} {O}_{5} ;$$

$${Li Z O}_{2} ;$$

$${LiNiVO}_{4} ;$$

$${Li}_{( 3 - f )} {{J}_{2} ( {PO}_{4} )}_{3} ( 0 \leq f \leq 2 ) ;$$

$${Li}_{( 3 - f )} {{Fe}_{2} ( {PO}_{4} )}_{3} ( 0 \leq f \leq 2 ) ; and$$

$${Li}_{a} {FePO}_{4} ( 0.9 \leq a \leq 1.8 ) .$$

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S. P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

For example, the positive electrode active material may include lithium nickel-based oxide represented by Chemical Formula 11, lithium cobalt-based oxide represented by Chemical Formula 12, a lithium iron phosphate-based compound represented by Chemical Formula 13, and cobalt-free lithium nickel-manganese-based oxide represented by Chemical Formula 14, or a combination thereof.

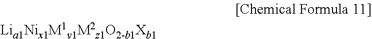

In Chemical Formula 11, 0.9≤a1≤1.8, 0.3≤x1≤1, 0≤y1≤0.7, 0≤z1≤0.7, 0.9≤x1+y1+z1≤1.1, 0≤b1≤0.1, M¹ and M² are one or more elements independently selected from Al, B, Ba, Ca, Ce, Co, Cr, Cu, Fe, Mg, Mn, Mo, Nb, Si, Sn, Sr, Tl, V, W, and Zr, and X is one or more elements selected from F, P, and S.

In Chemical Formula 11, 0.6≤x1≤1, 0≤y1≤0.4, and 0≤z1≤0.4 or 0.8≤x1≤1, 0≤y1≤0.2, and 0≤z1≤0.2.

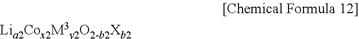

In Chemical Formula 12, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

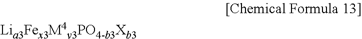

In Chemical Formula 13, 0.9≤a3≤1.8, 0.6≤x3≤1, 0≤y3≤0.4, and O≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn, and Zr, and X is one or more elements selected from F, P, and S.

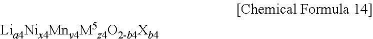

In Chemical Formula 14, 0.9≤a2≤1.8, 0.8≤x4<1, 0<y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

An average particle diameter (D50) of the positive electrode active material may be 1 μm to 25 μm, for example 3 μm to 25 μm, 1 μm to 20 μm, 1 μm to 18 μm, 3 μm to 15 μm, or 5 μm to 15 μm. For example, the positive electrode active material may include small particles having an average particle diameter (D50) of 1 μm to 9 μm and large particles having an average particle diameter (D50) of 10 μm to 25 μm. The positive electrode active material having this particle size range can be harmoniously mixed with other components within the positive electrode active material layer and can achieve high capacity and high energy density. Herein, the average particle diameter means a diameter (D50) of particles having a cumulative volume of 50 volume % in the particle size distribution that is obtained by measuring the size (diameter or length of the major axis) of about 20 particles at random in a scanning electron microscope image for positive electrode active materials.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

Meanwhile, the positive electrode active material may include a buffer layer on the surface of the particles. The buffer layer may be expressed as a coating layer, a protective layer, etc., and may serve to lower the interfacial resistance between the positive electrode active material and the sulfide-based solid electrolyte particles. For example, the buffer layer may include lithium-metal-oxide, wherein the metal may be for example one or more elements selected from Al, B, Ca, Ce, Cr, Fe, Mg, Mo, Nb, Si, Sn, Sr, Ta, V, W, and Zr. The lithium-metal-oxide improves the performance of the positive electrode active material by facilitating the movement of lithium ions and electronic conduction, and is improved for lowering the interfacial resistance between the positive electrode active material and solid electrolyte particles.

The positive electrode active material may be included in an amount of 55 wt % to 99 wt %, for example 65 wt % to 95 wt %, or 75 wt % to 91 wt % based on 100 wt % of the positive electrode active material layer.

### Binder

The binder serves to adhere the positive electrode active material particles to each other and also to properly attach the positive electrode active material to the current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

A content of the binder may be approximately 0.1 wt % to 5 wt % based on 100 wt % of the positive electrode active material layer in the positive electrode active material layer.

### Conductive Material

The positive electrode active material layer may further include a conductive material. The conductive material is used to impart conductivity to the electrode, and any material that does not cause chemical change and conducts electrons can be used in the battery. Examples thereof may include a carbon-based material such as natural graphite, artificial graphite, carbon black, acetylene black, ketjen black, a carbon fiber, a carbon nanofiber, a carbon nanotube, and the like; a metal-based material including copper, nickel, aluminum, silver, etc. in a form of a metal powder or a metal fiber; a conductive polymer such as a polyphenylene derivative; or a mixture thereof.

A content of the conductive material in the positive electrode active material layer may be 0 wt % to 3 wt %, 0.01 wt % to 2 wt %, or 0.1 wt % to 1 wt % based on 100 wt % of the positive electrode active material layer.

The solid electrolyte may be included in an amount of 0.1 wt % to 35 wt %, for example 1 wt % to 35 wt %, 5 wt % to 30 wt %, 8 wt % to 25 wt %, or 10 wt % to 20 wt % based on 100 wt % of the positive electrode active material layer.

Additionally, the positive electrode active material may be included in an amount of 5 wt % to 99 wt % and the solid electrolyte may be included in an amount of 1 wt % to 35 wt %, for example the positive electrode active material may be included in an amount of 80 wt % to 90 wt %, and the solid electrolyte may be included in an amount of 10 wt % to 20 wt % based on a total weight of the positive electrode active material and solid electrolyte in the positive electrode active material layer. If the solid electrolyte is included in the positive electrode at such an amount, the efficiency and cycle-life characteristics of the all-solid-state battery can be improved without reducing the capacity.

The positive electrode current collector may include an aluminum foil, but is not limited thereto.

An all-solid-state rechargeable battery may be a unit cell with a structure of positive electrode/solid electrolyte layer/negative electrode, a bicell with a structure of positive electrode/solid electrolyte layer/negative electrode/solid electrolyte layer/positive electrode, or a stacked battery in which the structure of the unit cell is repeated.

The shape of the all-solid-state rechargeable battery is not particularly limited, and may be, for example, coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, for example, in an electric bicycle or a power tool. In addition, the all-solid-state rechargeable battery may be used in various fields such as portable electronic devices.

### MODE FOR INVENTION

Hereinafter, examples and comparative examples of the present invention will be described. The following examples are only examples of the present invention and the present invention is not limited to the following examples.

### Example 1

### 1. Preparation of Solid Electrolyte

A solid electrolyte was prepared by mixing 93 mol % of argyrodite-type sulfide-based solid electrolyte particles (Li₆PS₅Cl, D50=3.5 μm) and 7 mol % of Bi₂S—₃ (Sigma Aldrich Co., Ltd.) at 10,000 rpm for about 1 minute by using a Lab. milling machine, heat-treating the mixture at 270° C. under an argon atmosphere for 2 hours by increasing a temperature at 1° C./min, and then, grinding it for 5 minutes.

### 2. Manufacturing of Solid Electrolyte Membrane

The solid electrolyte was added to and mixed with an isobutyryl isobutyrate (IBIB) solvent including an acrylic binder to prepare a slurry. The slurry included 98 wt % of a solid electrolyte and 2 wt % of a binder. The slurry was coated on a PET film with a blade coater, pre-dried at about 50° C., and then dried at about 70° C. under vacuum conditions to manufacture a solid electrolyte membrane having a thickness of about 100 to 150 μm.

3. Manufacturing of all-Solid-State Rechargeable Battery Cell

A positive electrode composition was prepared by mixing 85 wt % of LiNi_{0.8}Co_{0.15}Mn_{0.05}O₂ positive electrode active material coated with Li₂O—ZrO₂, 13.5 wt % of lithium argyrodite-type solid electrolyte Li₆PS₅Cl, 1.0 wt % of polyvinylidene fluoride binder, and 0.5 wt % of carbon nanotube conductive material. The prepared positive electrode composition was coated on a positive electrode current collector using a bar coater, dried, and compressed to manufacture a positive electrode.

An Ag/C composite was prepared by mixing carbon black having a primary particle size (D50) of about 30 nm and silver (Ag) having an average particle size (D50) of about 60 nm in a weight ratio of 3:1, and 0.25 g of the composite was added to 2 g of an NMP solution including 7 wt % of polyvinylidene fluoride binder and mixed to prepare a negative electrode coating layer composition. This was coated on a nickel foil current collector using a bar coater and vacuum dried to prepare a precipitation-type negative electrode in which a negative electrode coating layer was formed on the current collector.

A unit cell was manufactured by stacking a positive electrode, a solid electrolyte membrane, and a negative electrode in that order, and then placing this in a laminate film and subjecting it to warm isostatic pressing (WIP) at 80° C. and 500 MPa for 30 minutes to manufacture an all-solid-state rechargeable battery cell.

### Example 2

A solid electrolyte and an all-solid-state rechargeable battery cell were manufactured substantially in the same manner as in Example 1 except that the heat treatment was performed at 270° C. for 6 hours in the solid electrolyte manufacturing process.

### Example 3

A solid electrolyte and an all-solid-state rechargeable battery cell were manufactured substantially in the same manner as in Example 2 except that 4 mol % of B₂S—₃ and 96 mol % of the argyrodite-type sulfide-based solid electrolyte particles were used in the solid electrolyte manufacturing process.

### Example 4

A solid electrolyte and an all-solid-state rechargeable battery cell were manufactured substantially in the same manner as in Example 2 except that 1 mol % of B₂S—₃ and 99 mol % of the argyrodite-type sulfide-based solid electrolyte particles were used in the solid electrolyte manufacturing process.

### Example 5

A solid electrolyte and an all-solid-state rechargeable battery cell were manufactured substantially in the same manner as in Example 2 except that 0.5 mol % of B₂S—₃ and 99.5 mol % of the argyrodite-type sulfide-based solid electrolyte particles were used in the solid electrolyte manufacturing process.

### Example 6

A solid electrolyte and an all-solid-state rechargeable battery cell were manufactured substantially in the same manner as in Example 2 except that 0.25 mol % of B₂S—₃ and 99.75 mol % of the argyrodite-type sulfide-based solid electrolyte particles were used in the solid electrolyte manufacturing process.

### Example 7

A solid electrolyte and an all-solid-state rechargeable battery cell were manufactured substantially in the same manner as in Example 2 except that 0.1 mol % of B₂S—₃ and 99.9 mol % of the argyrodite-type sulfide-based solid electrolyte particles were used in the solid electrolyte manufacturing process.

### Comparative Example 1

A solid electrolyte and an all-solid-state rechargeable battery cell were manufactured substantially in the same manner as in Example 2 except that the argyrodite-type sulfide-based solid electrolyte particles (Li₃PS₅Cl) themselves were used as the solid electrolyte of the solid electrolyte membrane.

### Comparative Example 2

A solid electrolyte and an all-solid-state rechargeable battery cell were manufactured substantially in the same manner as in Example 2 except that B₂S—₃ was not used, and the heat treatment was performed at 270° C. for 6 hours in the solid electrolyte manufacturing process.

### Evaluation Example 1

The surface of each of the solid electrolytes according to Examples 1 and 2 was subjected to a quantitative analysis using XRD, and the results are shown in Table 1. In Table 1, a content (mol %) of each component is provided based on 100 mol % of the solid electrolyte.

TABLE 1

| | Li_{5.8}PS_{4.8}Cl_{1.2} | LiCl | LiBiS₂ | Bi₂S₃ |
|---|---|---|---|---|
| Example 1 (270 °C 2 h) | 89.3 | 1.9 | 3.5 | 5.3 |
| Example 2 (270 °C 6 h) | 86.2 | 3.3 | 8.3 | 2.2 |

Referring to Table 1, Examples 1 and 2 were confirmed that a LiBiS₂ phase was formed on the surface of each of the solid electrolytes. In addition, comparing Example 1 with Example 2, it was confirmed that the longer heat treatment time, the larger content of LiBiS₂.

### Evaluation Example 2

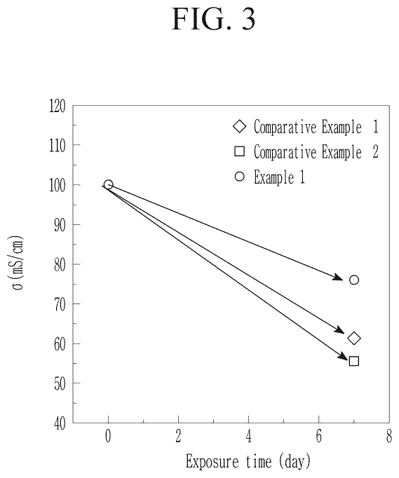

The solid electrolyte membranes of Examples 2 to 4 and Comparative Examples 1 and 2 were respectively interposed between SUS current collector and SUS current collector to manufacture symmetrical cells, which were pressed under a pressure of 6 tons for 2 minutes, and to which 4 Nm of torque was applied, preparing samples. The samples were allowed to stand in a dry room with a dew point of −45° C. or less to measure ionic conductivity changes for up to 7 days, and the results are shown in FIG. 3. In addition, a ratio of ionic conductivity after 7 days to initial ionic conductivity was multiplied by 100 to obtain an ionic conductivity retention rate (%), which is shown in Table 2.

TABLE 2

| | | σₑₓₚₒ | Ionic conductivity |
|---|---|---|---|
| | σₚᵣᵢₛ | (mScm⁻¹) | retention rate (%) |
| | (mScm⁻¹) | 7 days | after 7 days |
| Example 2 (7 mol %) | 1.21 | 0.92 | 76.03 |
| Example 3 (4 mol %) | 1.51 | 1.10 | 72.85 |
| Example 4 (1 mol %) | 1.85 | 1.36 | 73.51 |
| Comparative Example 1 | 1.66 | 1.02 | 61.45 |
| Comparative Example 2 | 1.84 | 1.02 | 55.56 |

Referring to FIG. 3 and Table 2, the solid electrolyte membranes of Examples 2 to 4, compared with those of Comparative Examples 1 and 2, were confirmed to exhibit an improved ionic conductivity retention rate under the dry room exposure conditions. Compared with that of Comparative Example 1, the ionic conductivity retention rate of Example 2 was improved by about 15% or more. This may be judged that the LiBiS₂ phase, which is sulfide-friendly, structurally stable, and moisture-repelling, was formed on the surface of the argyrodite-type sulfide-based solid electrolyte particles. The solid electrolyte membranes according to Examples 5 to 7 were measured with respect to ionic conductivity in the same manner as above and then, remeasured with respect to ionic conductivity after allowed to stand for 3 days in the dry room to calculate an ionic conductivity retention rate, and the results are shown in Table 3.

TABLE 3

| | | σₑₓₚₒ | |
|---|---|---|---|
| | σₚᵣᵢₛ | (mScm⁻¹) | σₑₓₚₒ/σₚᵣᵢₛ |
| | (mScm⁻¹) | 3 days | 3 days |
| Example 5 (0.5 mol %) | 2.48 | 2.00 | 80.65% |
| Example 6 (0.25 mol %) | 2.46 | 2.01 | 81.71% |
| Example 7 (0.1 mol %) | 2.47 | 1.92 | 77.73% |

Referring to Table 3, the solid electrolyte membranes of Example 5 to 7, compared with those of Comparative Examples 1 and 2, also were confirmed to exhibit an improved ionic conductivity retention rate after allowed to stand in the dry room. Furthermore, the solid electrolyte membranes of Example 5 to 7 exhibited improved ionic conductivity (σₚᵣᵢₛ) immediately after the Bi₂S₃ coating, compared with the solid electrolyte membranes of Examples 2 to 4, which confirmed that the decrease in initial ionic conductivity was reduced. Examples 5 and 6, which used 0.25 mol % to 0.5 mol % of a bismuth raw material, particularly exhibited a small decrease in the initial ionic conductivity and a high ionic conductivity retention rate after allowed to stand in the dry room.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: all-solid-state battery
201: positive electrode current collector
200: positive electrode
203: positive electrode active material layer
300: solid electrolyte layer
400: negative electrode
401: negative electrode current collector
403: negative electrode active material layer
400′: precipitation-type negative electrode
404: lithium metal layer
405: negative electrode coating layer
500: elastic layer

1. A solid electrolyte, comprising
argyrodite-type sulfide-based solid electrolyte particles and a bismuth (Bi) compound on the surface of the particles.

2. The solid electrolyte as claimed in claim 1, wherein
the bismuth compound is coated on at least a portion of the surface of the particle.

3. The solid electrolyte as claimed in claim 1, wherein
the bismuth compound is coated in a form of a continuous film on the surface of the particle.

4. The solid electrolyte as claimed in claim 1, wherein
the bismuth compound is coated in an island shape on the surface of the particle.

5. The solid electrolyte as claimed in claim 1, wherein
the bismuth compound further comprises sulfur.

6. The solid electrolyte as claimed in claim 1, wherein
the bismuth compound further comprises lithium.

7. The solid electrolyte as claimed in claim 1, wherein
the bismuth compound comprises Bi₂S₃, Bi₂O₅, Bi₂Se₃, BiF₃, BiF₅, BiCl₃, LiBi, Li₃Bi, LiBiS₂, NaBis₂, LiBiO₂, LiBiO₃, Li₃BiO₄, Li₃BiO₅, Li₇BiO₆, Li₃BiO₃, Na₃BiO₃, LiBiSe₂, NaBiSe₂, KBiSe₂, BiOCl, BiONO₃, LiBi(PO₃)₄, or a combination thereof.

8. The solid electrolyte as claimed in claim 1, wherein
the bismuth compound comprises LiBiS₂.

9. The solid electrolyte as claimed in claim 1, wherein
the bismuth compound is included in an amount of 0.05 mol % to 10 mol % based on 100 mol % of the solid electrolyte.

10. The solid electrolyte as claimed in claim 1, wherein
the bismuth compound is included in an amount of 0.1 mol % to 1 mol % based on 100 mol % of the solid electrolyte.

11. The solid electrolyte as claimed in claim 1, wherein
an average particle diameter of the argyrodite-type sulfide-based solid electrolyte particles is 0.1 μm to 5.0 μm.

12. The solid electrolyte as claimed in claim 1, wherein
the argyrodite-type sulfide-based solid electrolyte particles comprise a compound represented by Chemical Formula 1: 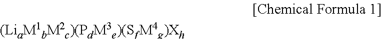
wherein in Chemical Formula 1,
4≤a≤8,
M¹ is Mg, Cu, Ag, or a combination thereof, 0≤b<0.5,
M² is Na, K, or a combination thereof, 0≤c<0.5,
M³ is Sn, Zn, Si, Sb, Ge, or a combination thereof, 0<d<4, 0≤e<1,
M⁴ is O, SOₙ, or a combination thereof, 1.5≤n≤5, 3≤f<12, 0≤g≤2, and
X is F, Cl, Br, I, or a combination thereof, 0≤h≤2.

13. The solid electrolyte as claimed in claim 1, wherein
the argyrodite-type sulfide-based solid electrolyte particles comprise Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}Cu_{0.06})PS_{4.75}Cl_{1.25}, (Li_{5.72}CU_{0.03})PS_{4.75}Cl_{1.25}, (Li_{5.69}Cu_{0.06})P(S_{4.70}(SO₄)_{0.05})Cl_{1.25}, (Li_{5.69}CU_{0.06})P(S_{4.60}(SO₄)_{0.15})Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.025})Cl_{1.25}, Li_{5.75}P(S_{4.725}(SO₄)_{0.025})Cl_{1.25}, or a combination thereof.

14. A method for preparing a solid electrolyte, comprising
mixing argyrodite-type sulfide-based solid electrolyte particles and a bismuth raw material and heat-treating at 200° C. to 350° C. to obtain the solid electrolyte as claimed in claim 1.

15. The method as claimed in claim 14, wherein
the heat treatment is performed for 2 hours to 10 hours.

16. The method as claimed in claim 14, wherein
the bismuth raw material comprises Bi₂S₃, Bi₂O₅, Bi₂Se₃, BiF₃, BiF₅, or a combination thereof.

17. The method as claimed in claim 14, wherein
wherein the bismuth raw material is mixed in an amount of 0.05 mol % to 10 mol % based on 100 mol % of a total of the argyrodite-type sulfide-based solid electrolyte particles and the bismuth raw material.

18. The method as claimed in claim 14, wherein
the bismuth raw material is mixed in an amount of 0.1 mol % to 1 mol % based on 100 mol % of a total of the argyrodite-type sulfide-based solid electrolyte particles and the bismuth raw material.

19. A solid electrolyte membrane comprising the solid electrolyte of claim 1.

20. An all-solid-state rechargeable battery, comprising
a positive electrode,
a negative electrode, and
the solid electrolyte membrane between the positive electrode and the negative electrode,
wherein at least one of the positive electrode, negative electrode, and solid electrolyte layer comprises the solid electrolyte of claim 1.
